(19) United States
(12) Patent Application Publication
(10) Pub. No.: US 2005/0117516 A1
(43) Pub. Date: Jun. 2, 2005

(54) Apparatus and method for displaying data rates in a wireless terminal

(75) Inventor: Jae-Duk Yang, Delseo-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/973,438

(22) Filed: Oct. 27, 2004

(30) Foreign Application Priority Data
Nov. 29, 2003 (KR) 2003-85977

(51) Int. Cl. H04J 1/16

(52) U.S. Cl. 370/232

(57) ABSTRACT

Apparatus and method for displaying a data rate of a wireless terminal are provided. The apparatus and method comprise transferring a first data frame for measuring a transmission data rate of the wireless terminal to a base station; receiving a second data frame for measuring a reception data rate of the wireless terminal from the base station; and displaying the data rate of the wireless terminal by measuring the data rate through the first and the second data frames.

### PRIORITY

This application claims the benefit under 35 U.S.C. § 119(a) of an application entitled “Method for displaying data rate in wireless terminal” filed in the Korean Intellectual Property Office on Nov. 29, 2003 and assigned Serial No. 2003-85977, the entire contents of which are incorporated herein by reference.

### BACKGROUND OF THE INVENTION

1. Field of the Invention

The present invention relates to an apparatus and method for displaying a data rate in a wireless terminal. More particularly, the present invention relates to an apparatus and method for displaying a data communication rate after measuring the data communication rate when a wireless terminal is in a waiting mode.

2. Description of the Related Art

A conventional wireless terminal shows a signal strength bar having an antenna shape in a display module in order to display a receiving sensitivity or signal strength. Accordingly, a user utilizing the wireless terminal sees a current receiving sensitivity of the wireless terminal and determines whether or not the wireless terminal is in a coverage area on the basis of the receiving sensitivity, which is convenient for the user. Also, in a waiting mode, the wireless terminal detects a transmission frequency and power through a monitoring channel in order to detect the transmission power of a present base station within a cell in which the wireless terminal is currently located. Also, the wireless terminal displays an intensity level of the detected transmission power as a shape of an antenna bar on a screen thereof. The base station allows the wireless terminal to monitor the transmission power of the base station at a proper time according to a predetermined period of time called a “paging time”. However, as data communication has developed, in a Code Division Multiple Access (CDMA) method and a General Packet Radio Service (GPRS) method or an Enhanced Data rates for GSM Evolution (EDGE) method, which has been widely used for the wireless terminal in Europe, a current data transmission rate is not displayed even if data communication is performed. In particular, when a user performs data communication in a waiting mode, a user does not know the data connection rate.

### SUMMARY OF THE INVENTION

Accordingly, the present invention has been made to solve the above-mentioned problems occurring in the prior art and to achieve other advantages. An object of the present invention is to provide an apparatus and method for displaying a transmission data rate and a reception data rate on a wireless terminal by measuring the transmission data rate and the reception data rate by transmitting and receiving signals at a predetermined time while in a waiting mode of the wireless terminal.

In order to accomplish this object, an apparatus and method for displaying a data rate of a wireless terminal are provided. The apparatus and method comprise transferring a first data frame for measuring a transmission data rate of the wireless terminal to a base station; receiving a second data frame for measuring a reception data rate of the wireless terminal from the base station; and displaying the data rate of the wireless terminal by measuring the data rate through the first and the second data frames.

In order to accomplish this object, an apparatus and method for displaying a data rate of a wireless terminal are provided. The apparatus and method comprise checking whether or not a predetermined time elapses when the wireless terminal is in a waiting mode; transferring a first data frame for measuring a transmission data rate of the wireless terminal to a base station if the predetermined time elapses; allowing the base station to measure the transmission data rate of the wireless terminal by means of the first data frame when receiving the first data frame; storing measured transmission data rate information in a second data frame for measuring a reception data rate of the wireless terminal so as to transfer the second data frame to the wireless terminal; allowing the wireless terminal to measure the reception data rate of the wireless terminal by means of the second data frame when receiving the second data frame; and displaying a measured reception data rate of the wireless terminal and the transmission data rate of the wireless terminal stored in the second data frame through a displaying module.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a structure of a wireless terminal according to an embodiment of the present invention;

FIG. 2 is a flow chart illustrating a method for displaying a data rate after measuring the data rate in a wireless terminal according to an embodiment of the present invention;

FIG. 3 is a diagram illustrating a procedure of transmitting and receiving data rate information between a wireless terminal and a base station according to an embodiment of the present invention;

FIG. 4A is a diagram illustrating a first data frame transferred from a wireless terminal to a base station of FIG. 3; and

FIG. 4B is a diagram illustrating a second data frame transferred from the base station to the wireless terminal of FIG. 3.

In the drawings, it should be understood that the same reference numerals are used throughout the drawings.

### DETAILED DESCRIPTION OF THE PREFERRED EMBODIMENT

An embodiment of the present invention will be described in detail with reference to the accompanying drawings. In the following description of the present invention, a detailed description of known functions and configurations incorporated herein will be omitted for conciseness.

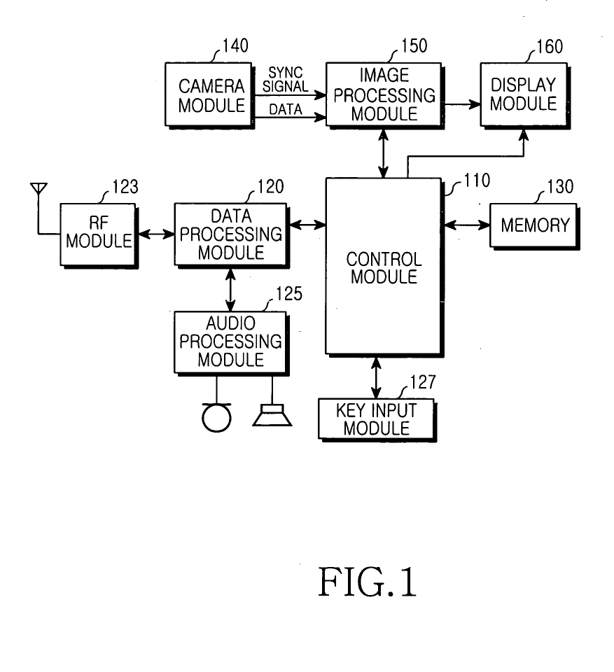

FIG. 1 is a diagram illustrating a structure of a wireless terminal according to an embodiment of the present invention in which the wireless terminal has a camera.

Referring to FIG. 1, an RF module 123 performs wireless communication functions. The RF module 123 includes an RF transmitter (not shown), which amplifies and up-converts frequencies of transmitted signals, and an RF receiver (not shown), which low-noise amplifies and down-converts transmitted signals. A data processing module 120 includes a transmitter (not shown), which encodes and modulates the transmitted signals, and a receiver (not shown), which decodes and demodulates the received signals. The data processing module 120 may include a MODEM and a CODEC. Herein, the CODEC includes a data CODEC processing packet data, and an audio CODEC processing audio signals such as voices. An audio processing module 125 replays reception audio signals output from the audio CODEC of the data processing module 120 or transfers transmission audio signals generated from a microphone to the audio CODEC of the data processing module 120.

A memory 130 may include a program memory or a data memory. The program memory may have programs for controlling general functions of a wireless terminal and programs for controlling the wireless terminal in such a manner that a data rate of the wireless terminal is measured by means of a predetermined signal transmitted or received when the wireless terminal is in a waiting mode according to an embodiment of the present invention and displayed. Also, the data memory temporarily has data generated while executing the programs.

A control module 110 controls entire operations of the wireless terminal. Also, the control module 110 may include the data processing module 120. Furthermore, the control module 110 controls the wireless terminal in such a manner that the wireless terminal transmits a first data frame for measuring a transmission data rate thereof to a base station by a predetermined period of time in a waiting mode and measures a data rate thereof by means of a second data frame for measuring a reception data rate of the wireless terminal received from the base station so as to display the reception data rate according to an embodiment of the present invention.

A camera module 140 photographs image data. Furthermore, the camera module 140 includes a camera sensor for converting photographed light signals into electric signals and a signal processing part for converting analog image signals photographed from the camera sensor into digital data. Herein, the camera sensor may be a Charge Coupled Device (CCD) sensor, and the signal processing part can be realized by means of a digital signal processor (DSP). Also, the camera sensor can be integrally formed with the signal processing part, or separately formed from each other.

An image processing module 150 generates display data for displaying image signals output from the camera module 140. The image processing module 150 processes image data output from the camera module 140 in a frame unit and outputs frame image data according to characteristics and the size of a display module 160. Also, the image processing module 150 includes an image CODEC so as to compress the frame image data displayed on the display module 160 by means of an established method, or uncompress the compressed frame image data into original frame image data. Herein, the image CODEC may be a Joint Photographic Experts Group (JPEG) CODEC, a Moving Picture Experts Group 4 (MPEG4) CODEC, a Wavelet CODEC, or any other suitable CODEC. On the assumption that the image processing module 150 has an on screen display (OSD) function, the image process module 150 may output OSD data according to the size of a screen displayed under the control of the control module 110.

The display module 160 displays image signals output from the image processing module 150 through a screen and user data output from the control part 110. Herein, the display module 160 may employ a Liquid Crystal Display (LCD). If the LCD is employed, the display module 160 may include a LCD controller module, a memory used for storing image data, and a LCD display element. Herein, if the LCD is realized in a touch screen, the display module 160 may be operated as an input module. In addition, the display module 160 displays a data rate of the wireless terminal measured by a predetermined period of time according to an embodiment of the present invention. Herein, the data rate can be variously displayed in a shape of an antenna or a bar, numerals, and so on.

A key input module 127 includes keys used for inputting numerals and letters and function keys used for setting various functions.

Hereinafter, an operation of the wireless terminalmeasureing a data rate and displaying a measured data rate will now be described. The control module 110 transfers the first data frame used for measuring a transmission data rate of the wireless terminal to the base station when the wireless terminal is in a waiting mode. The base station, which has received the first data frame, measures the transmission data rate of the wireless terminal by means of the first data frame. The base station stores the measured transmission data rate of the wireless terminal in the second data frame used for measuring a reception data rate of the wireless terminal so as to transfer the second data frame to the wireless terminal. The control module 110, detects reception of the second data frame, measures the reception data rate of the wireless terminal by means of the second data frame, detects the transmission data rate of the wireless terminal and displays the transmission data rate on the display module 160.

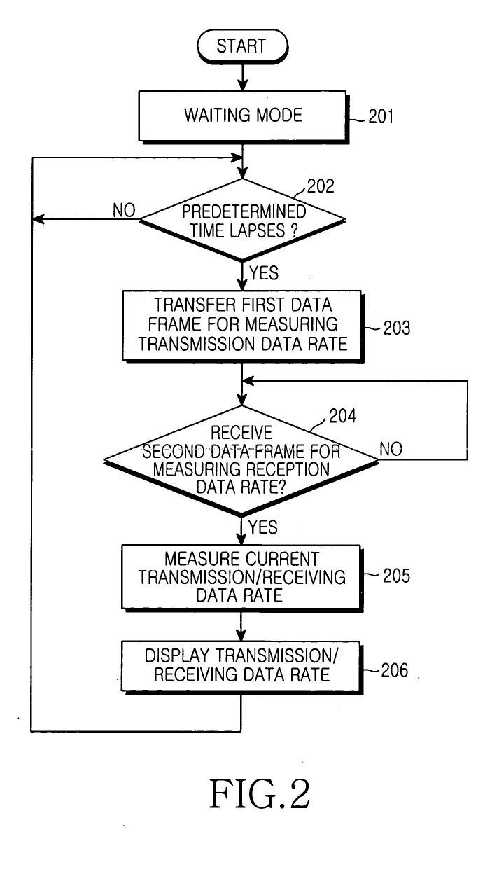

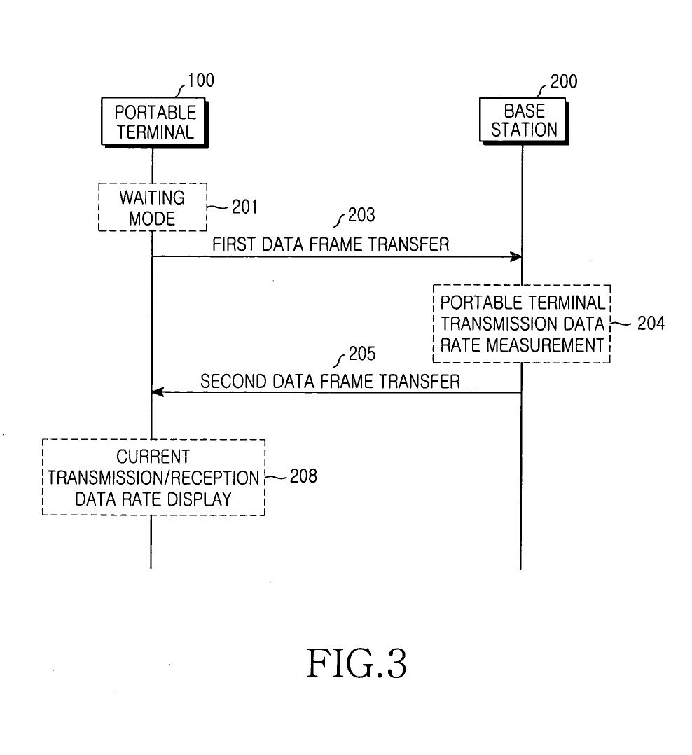

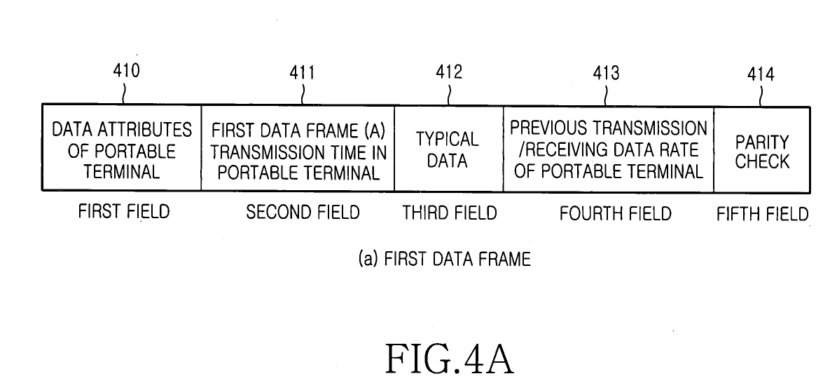

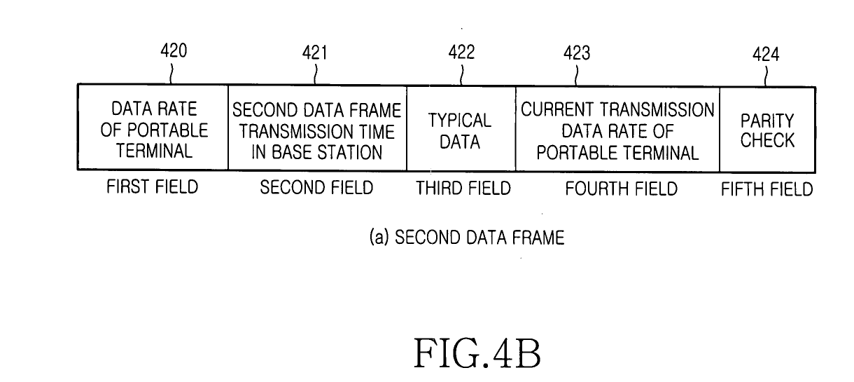

FIG. 2 is a flow chart illustrating a method for measuring and displaying a data rate in a wireless terminal according to an embodiment of the present invention, and FIG. 3 is a diagram illustrating a procedure for transmitting and receiving data rate information between a wireless terminal and a base station according to an embodiment of the present invention. FIG. 4A is a diagram illustrating the first data frame transferred from the wireless terminal to the base station of FIG. 3, and FIG. 4B is a diagram illustrating the second data frame transferred from the base station to the wireless terminal of FIG. 3.

Hereinafter, an embodiment of the present invention will now be described in detail with reference to FIGS. 1 to 4B.

If a predetermined period of time elapses in step 201 representing a waiting mode, the control module 110 detects that a predetermined period of time has elapsed in step 202. Thereafter, the control module 110 transfers the first data frame used for measuring a transmission data rate of the wireless terminal to the base station 200. Herein, the first data frame transferred to the base station 200 will be described in detail with reference to FIG. 4A. Referring to FIG. 4A, the first data frame (a) includes a first field 410 having attribute information of data transmitted from the wireless terminal, a second field 411 having information regarding a transmission start time for the first data frame (a) from the wireless terminal 100 to the base station 200, a third field 412 having typical data assigned between the wireless terminal and the base station, a fourth field 413 having transmission and reception information of previous data of the wireless terminal, and a fifth field 414 having a parity used for checking whether or not a loss of data transferred from the wireless terminal exists. The first field 411 determines data attributes sent from the wireless terminal. In case of a wireless terminal employing an Enhanced Data rates for GSM Evolution (EDGE)/General Packet Radio Service (GPRS) method, the data attributes are represented as three attributes, which are a mode (EDGE/GPRS), a class (1-12), and a code scheme (MCS1-9/CS1-4). For example, the first field 411 may have data attributes that the mode, the class, and the code scheme correspond to “EDGE”, “8”, and “MCS 9”, respectively. The second field 411 is information of time when the wireless terminal transmits the first data frame. Herein, the wireless terminal can measure an uploading data rate on the basis of information of the time. The third field 412 has data assigned between the wireless terminal 100 and the base station 200. Herein, the base station 200 receives the data stored in the third field 412 so as to analyze the data and measures the uploading data rate on the basis of the amount of data received in each predetermined period of time. The fourth field 413 is used when a network finds a data rate of the wireless terminal located in a coverage area of the bases station 200. Furthermore, the fourth field 413 is used when a data rate previously displayed to a user of the wireless terminal is delivered to the base station 200 so that the base station 200 finds the current data rate of the network.

The base station 200 receiving the first data frame (a) shown in FIG. 4A measures the amount of data of the third field 412, which has been received in the base station 200 for a predetermined time from the transmission time of the first data frame obtained through the second field 411 of the first data frame to a receiving time of the first data frame in the base station 200, thereby measuring the transmission data rate of the wireless terminal through step 203 shown in FIG. 3. Thereafter, step 204 shown in FIG. 3 is performed, in which the base station 200 transfers the second data frame having a measured transmission data rate of the wireless terminal to the wireless terminal 100. Hereinafter, the second data frame transmitted to the wireless terminal 100 will be described with reference to FIG. 4B. Referring to FIG. 4B, the second data frame (b) includes a first field 420 having attribute information of data sent from the wireless terminal, a second field 421 having information regarding a start time for transmitting the second data frame (B) from the base station 200 to the wireless terminal 100, the third field 422 having typical data assigned between the wireless terminal and the base station, a fourth field 423 having the transmission and reception data information of the wireless terminal measured in step 205, and a fifth field 424 having a parity for checking whether or not a loss of data transferred from the wireless terminal exists. The first field 420 is identical to the first field 411 of the first data frame (a) and is stored in the second data frame (b) in order to report network conditions varying in real time in a network so as to be transferred. The second field 421 is information of time when the base station 200 transmits the second data frame (b). Herein, the wireless terminal 100 can measure a downloading data rate on the basis of information of the time. The third field 422 has data assigned between the wireless terminal 100 and the base station 200. Herein, the wireless terminal receives the data stored in the third field 422 so as to analyze the data and measures a downloading data rate on the basis of the amount of data received in each predetermined period of time. The fourth field 423 represents the transmission data rate of the wireless terminal measured by the base station 200 through the first data frame (a). The fifth field 424 is used for secure recovery of the whole data transmitted from the base station 200.

When the second data frame (b) shown in FIG. 4B is received, the control module 110 of the wireless terminal perceives reception of the second data frame (b) in step 204 and performs step 205 for measuring the transmission and reception data rate of the wireless terminal. In step 205, the control module 11 calculates the amount of data of the third field 422 received for a predetermined time from the transmission time of the second data frame obtained through the second field 421 of the second data frame to a receiving time of the second data frame in the wireless terminal 100, thereby measuring the reception data rate of the wireless terminal. Also, the control module 110 detects the transmission data rate of the wireless terminal through the fourth field 423 of the second data frame. Thereafter, the control module 110 performs step 206 for displaying the measured transmission and reception data rate of the wireless terminal on the display module 160. Herein, the display module 160 can variously display the measured transmission and reception data rate of the wireless terminal in a shape of an antenna or a bar, numerals, and so on. Also, the display module 160 can display the potential for data transmission, and a data rate when transmitting data, to notify a user of the data transmission potential and the data rate. After displaying the data rate of the wireless terminal on the display module 160, the control module 100 determines whether or not a predetermined period of time elapses. If the predetermined time elapses, after the control module 100 becomes aware that the predetermined time elapses in step 202, the control module 100 repeatedly performs steps 203 to 206.

The wireless terminal 100 confirms a connection between the wireless terminal 100 and the base station 200 through a paging channel when the wireless terminal is in a waiting mode of step 201. Also, the wireless terminal 100 provides the first data frame to the base station 200 and receives the second data frame from the base station 200 by a predetermined period of time, so that it is possible to confirm a data rate of the wireless terminal. Accordingly, a wireless terminal employing an EDGE/GPRS method, and so on, employs currently used Random Access Channel (RACH) and Access Grant Channel (AGCH) channels, and the RACH and the AGCH channels are allotted to the first and the second data frames, respectively, so that it is possible to transmit and receive the first and the second data frames by a predetermined period of time. Also, data according to an embodiment of the present invention are added to existing data of established channels so that the data are transmitted and received. Also, the first and the second data frames can be provided by allotting new channels.

In a network, the wireless terminal employing the EDGE/GPRS method sends individual data of the wireless terminal to the base station by means of the RACH channel. Thereafter, the wireless terminal confirms that the wireless terminal has been connected with the base station during a paging time interval by means of the AGCH channel sent from the base station. Herein, according to an embodiment of the present invention, an additional new data rate confirmation channel is allotted. If the first and the second data frames are transmitted or received through the additional new data rate confirmation channel, the data rate confirmation channel is operated for a longer time period than the paging time.

Therefore, according to an embodiment of the present invention, a data rate is measured and displayed in a waiting mode of the wireless terminal, so that a user utilizing the wireless terminal can easily find uploading and downloading data rates of the wireless terminal located in a base station coverage area. Also, the user can find using the display module whether or not the current wireless terminal can transfer data and a data rate when transferring data, so that the user can solve problems with incompatible data rates. In particular, in high rate data communication employing the EDGE method, it is possible for the wireless terminal to have a high-speed data rate.

While the invention has been shown and described with reference to a certain embodiments thereof, it should be understood by those skilled in the art that various changes in form and details may be made therein without departing from the spirit and scope of the invention. Consequently, the scope of the invention should not be limited to the embodiments, but should be defined by the appended claims and equivalents thereof.

1. A method for displaying a data rate of a wireless terminal, the method comprising the steps of:
transferring a first data frame for measuring a transmission data rate of the wireless terminal to a base station;
receiving a second data frame for measuring a reception data rate of the wireless terminal from the base station; and
displaying the data rate of the wireless terminal by measuring the data rate through the first and the second data frames.

2. The method as claimed in claim 1, wherein the second data frame includes transmission data rate information of the wireless terminal measured by the base station.

3. The method as claimed in claim 1, wherein the first data frame includes a first field having attribute information of data transferred by the wireless terminal, a second field having time information at which the wireless terminal transmits the first data frame, a third field having typical data assigned between the wireless terminal and the base station, a fourth field having information of previous transmission and reception data rates of the wireless terminal, and a fifth field having a parity for determining whether or not a loss of data transferred from the wireless terminal exists.

4. The method as claimed in claim 1, wherein the second data frame includes a first field having attribute information of data transferred from the wireless terminal, a second field having time information at which the base station transmits the second data frame, a third field having typical data assigned between the wireless terminal and the base station, a fourth field having information of a transmission data rate of the wireless terminal measured by the base station, and a fifth field having a parity for determining whether or not a loss of data transferred from the wireless terminal exists.

5. A method for displaying a data rate of a wireless terminal, the method comprising the steps of:
determining whether or not a predetermined time elapses when the wireless terminal is in a waiting mode;
transferring a first data frame for measuring a transmission data rate of the wireless terminal to a base station if the predetermined time elapses;
allowing the base station to measure the transmission data rate of the wireless terminal by means of the first data frame when receiving the first data frame;
storing measured transmission data rate information in a second data frame for measuring a reception data rate of the wireless terminal in order to transfer the second data frame to the wireless terminal;
allowing the wireless terminal to measure the reception data rate of the wireless terminal by means of the second data frame when receiving the second data frame; and
displaying a measured reception data rate of the wireless terminal and the transmission data rate of the wireless terminal stored in the second data frame through a displaying module.

6. The method as claimed in claim 5, wherein the base station measures the transmission data rate of the wireless terminal based on time information representing a transmission time of the first data frame from the wireless terminal and typical data assigned between the wireless terminal and the base station, which are stored in the first data frame.

7. The method as claimed in claim 5, wherein the wireless terminal measures the reception data rate of the wireless terminal by means of typical data assigned between the wireless terminal and the base station, and time information representing a transmission time of the second data frame from the base station, which are stored in the second data frame.

8. An apparatus for displaying a data rate of a wireless terminal, the apparatus comprises:
a radio frequency module adapted to receive and transmit radio frequency signals;
a data processing module adapted to modulate and demodulate signals;
a memory adapted to store programs for performing wireless functions of the wireless terminal;
a display module adapted to display signal strength and data rate information of the wireless terminal;
a controller adapted to transfer a first data frame for measuring a transmission data rate of the wireless terminal to a base station, receive a second data frame for measuring a reception data rate of the wireless terminal from the base station, and display the data rate of the wireless terminal on the display module by measuring the data rate through the first and the second data frames.

9. The apparatus as claimed in claim 8, wherein the second data frame includes transmission data rate information of the wireless terminal measured by the base station.

10. The apparatus as claimed in claim 8, wherein the first data frame includes a first field having attribute information of data transferred by the wireless terminal, a second field having time information at which the wireless terminal transmits the first data frame, a third field having typical data assigned between the wireless terminal and the base station, a fourth field having information of previous transmission and reception data rates of the wireless terminal, and a fifth field having a parity for determining whether or not a loss of data transferred from the wireless terminal exists.

11. The apparatus as claimed in claim 8, wherein the second data frame includes a first field having attribute information of data transferred from the wireless terminal, a second field having time information at which the base station transmits the second data frame, a third field having typical data assigned between the wireless terminal and the base station, a fourth field having information of a transmission data rate of the wireless terminal measured by the base station, and a fifth field having a parity for determining whether or not a loss of data transferred from the wireless terminal exists.

12. An apparatus for displaying a data rate of a wireless terminal, the apparatus comprises:
a radio frequency module adapted to receive and transmit radio frequency signals;
a data processing module adapted to modulate and demodulate signals;
a memory adapted to store programs for performing wireless functions of the wireless terminal;
a display module adapted to display signal strength and data rate information of the wireless terminal;
a controller adapted to determine whether or not a predetermined time elapses when the wireless terminal is in a waiting mode, transfer a first data frame for measuring a transmission data rate of the wireless terminal to a base station if the predetermined time elapses, allowing the base station to measure the transmission data rate of the wireless terminal by means of the first data frame when receiving the first data frame, store measured transmission data rate information in a second data frame for measuring a reception data rate of the wireless terminal in order to transfer the second data frame to the wireless terminal, allow the wireless terminal to measure the reception data rate of the wireless terminal by means of the second data frame when receiving the second data frame, and display a measured reception data rate of the wireless terminal and the transmission data rate of the wireless terminal stored in the second data frame through the displaying module.

13. The apparatus as claimed in claim 12, wherein the base station measures the transmission data rate of the wireless terminal based on time information representing a transmission time of the first data frame from the wireless terminal and typical data assigned between the wireless terminal and the base station, which are stored in the first data frame.

14. The apparatus as claimed in claim 12, wherein the wireless terminal measures the reception data rate of the wireless terminal by means of typical data assigned between the wireless terminal and the base station, and time information representing a transmission time of the second data frame from the base station, which are stored in the second data frame.
